(19) United States
(12) Patent Application Publication
(10) Pub. No.: US 2026/0064085 A1
(43) Pub. Date: Mar. 5, 2026

(54) ELECTRONIC DEVICE AND ELECTRONIC TIMEPIECE

(71) Applicant: CASIO COMPUTER CO., LTD., Tokyo (JP)

(72) Inventor: Hiroyuki HOSOBUCHI, Tokyo (JP)

(21) Appl. No.: 19/319,014

(22) Filed: Sep. 4, 2025

(30) Foreign Application Priority Data
Sep. 5, 2024 (JP) 2024-152812

(51) Int. Cl. G04G 21/08; H01H 13/20

(52) U.S. Cl. CPC G04G 21/08; H01H 13/20

(57) ABSTRACT

A module includes a plate spring and a substrate. The plate spring includes a fixed first end and extends from the first end in a first direction. The substrate includes an electrode that contacts a second end of the plate spring opposite the first end in response to a first point of the plate spring being pressed by a pushbutton switch being pressed and does not contact the second end in response to the first point being not pressed. The plate spring further includes a first bend between the first point and the second end. A direction from the first bend to the second end and a direction from the first point to the first bend are opposite in a component along the first direction.

### REFERENCE TO RELATED APPLICATIONS

This application claims priority from Application No. 2024-152812, filed in Japan on Sep. 5, 2024, and incorporates the entire contents of the basic application into this application.

### TECHNICAL FIELD

The present disclosure relates to an electronic device and an electronic timepiece.

### DESCRIPTION OF RELATED ART

For example, in JP S56-174430 U, there is disclosed a switch structure including a plate spring (switch contact spring) and a substrate (circuit board). The plate spring extends from a first end (fixed part). The substrate includes an electrode (fixed terminal member) that contacts a second end (end) of the plate spring opposite the first end if a first point of the plate spring is pressed by a pushbutton switch (button) being pressed and does not contact the second end if the first point is not pressed.

### SUMMARY OF THE INVENTION

According to an aspect of the present disclosure, there is provided a module including:
a plate spring including a fixed first end and extending from the first end in a first direction; and
a substrate including an electrode that contacts a second end of the plate spring opposite the first end in response to a first point of the plate spring being pressed by a pushbutton switch being pressed and does not contact the second end in response to the first point being not pressed,
wherein the plate spring further includes a first bend between the first point and the second end, and
wherein a direction from the first bend to the second end and a direction from the first point to the first bend are opposite in a component along the first direction.

Further features of the present invention will become apparent from the following description of exemplary embodiments (with reference to the attached drawings).

### BRIEF DESCRIPTION OF DRAWINGS

FIG. 1 is a bottom view of an electronic timepiece of an embodiment, showing the configuration thereof.

FIG. 2 is a perspective view of a module, showing the external appearance thereof.

FIG. 3A shows a plate spring.

FIG. 3B shows the plate spring.

FIG. 3C shows the plate spring.

FIG. 4A shows the plate spring with no press operation on a pushbutton switch.

FIG. 4B shows movement of the plate spring in response to a press operation on the pushbutton switch.

FIG. 4C shows movement of the plate spring in response to a greater impact on the pushbutton switch than the press operation.

FIG. 5A shows a plate spring of a first modification of the embodiment.

FIG. 5B shows a plate spring of a second modification of the embodiment.

### DETAILED DESCRIPTION

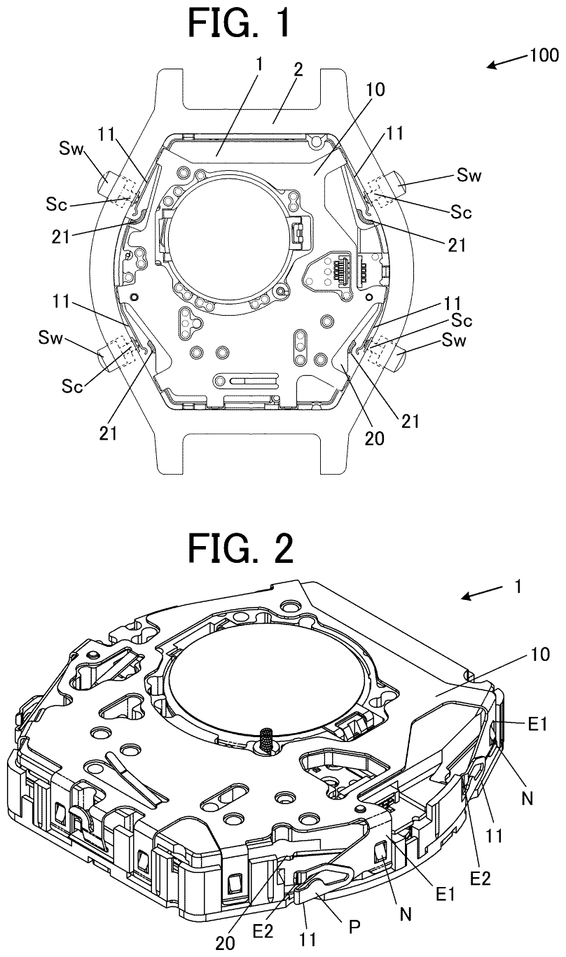

Hereinafter, one or more embodiments of the present disclosure will be described with reference to the drawings. An electronic timepiece 100 is an embodiment of the electronic device of the present disclosure and may be a wristwatch as shown by the bottom view in FIG. 1. In the electronic timepiece 100, a module 1 is housed in a case 2 and supported/held by a holding member 10. The module 1 is an assembly relevant to functional actions of the electronic timepiece 100 and includes a substrate 20. The case 2 has a cylindrical shape with the upper surface and the lower surface opened. In the opening in the upper surface of the case 2, a display is located so as to cover the module 1. The lower surface of the case 2 may be sealed with a not-shown bottom cover.

On the lateral surface of the electronic timepiece 100, pushbutton switches Sw as operation members are located. Each pushbutton switch Sw protrudes on/from the lateral surface for a user to make a press operation thereon, and includes a shaft Sc that passes through the case 2. One end of the shaft Sc contacts a plate spring 11 in response to a press operation on the pushbutton switch Sw and pushes the plate spring 11 inward. The plate spring 11 will be described later. In a state in which the pushbutton switch Sw is not pressed, the shaft Sc and the plate spring 11 may be or may not be in contact with one another. By being pushed inward, the plate spring 11 contacts an electrode 21, i.e., its corresponding electrode 21 among electrodes 21, located on the substrate 20. Thus, the press operation on the pushbutton switch Sw is detected.

The substrate 20 is a plate-like member having, for example, electronic components that perform various actions of the electronic timepiece 100 and an electronic circuit and connection terminals that connect these electronic components. The electronic components may include, for example, a microcontroller, a storage, such as an external flash memory, a large-capacitance capacitor, functional modules for various functional actions, such as communication and measurement, and a crystal oscillator. The substrate 20 is supplied with electric power from a battery and causes s the electronic components and so forth to act. For example, the microcontroller calculates the date and time using clock signals corresponding to oscillations of the crystal oscillator. The microcontroller also causes the display screen located under the crystal to display the time and so forth. The substrate 20 may be a multi-layer substrate, which is composed of multiple layers. The electrodes 21 are located on the lateral surface of the substrate 20 to be exposed.

As shown by the perspective view in FIG. 2, in the module 1 of the electronic timepiece 100, the substrate 20 and so forth are housed in and held by the frame-like holding member 10. The plate spring 11 is a component that is continuous from the holding member 10 and extends to the lateral surface of the module 1. The plate spring 11 has a first end E1 that is a root part apart from the holding member 10. The first end E1 is fixed by a claw N. The plate spring 11 extends from this fixed first end E1. The holding member 10 is a conductor having a necessary degree of strength for fixation, and in this embodiment, a metal member. The holding member 10 constitutes a case ground plane.

The plate spring 11 deforms by the shaft Sc of the pushbutton switch Sw pressing a first point P toward the inside of the electronic timepiece 100. The plate spring 11 has a second end E2 opposite the first end E1. The second end E2, i.e., the tip on a movable side, contacts the electrode 21 located on the lateral surface of the substrate 20 by the deformation of the plate spring 11. Normally, this deformation is elastic deformation, and therefore when the press operation on the pushbutton switch Sw is released, the deformation of the plate spring 11 is cancelled, i.e., the plate spring 11 returns to its original state. That is, the second end E2 is not in contact with the electrode 21 while the plate spring 11 is not pressed by, for example, the press operation on the pushbutton switch Sw. The shaft Sc may surface-contact the plate spring 11. In this case, the first point P may be a representative point in a contact area with the shaft Sc in the plate spring 11, e.g., the center point in the contact area.

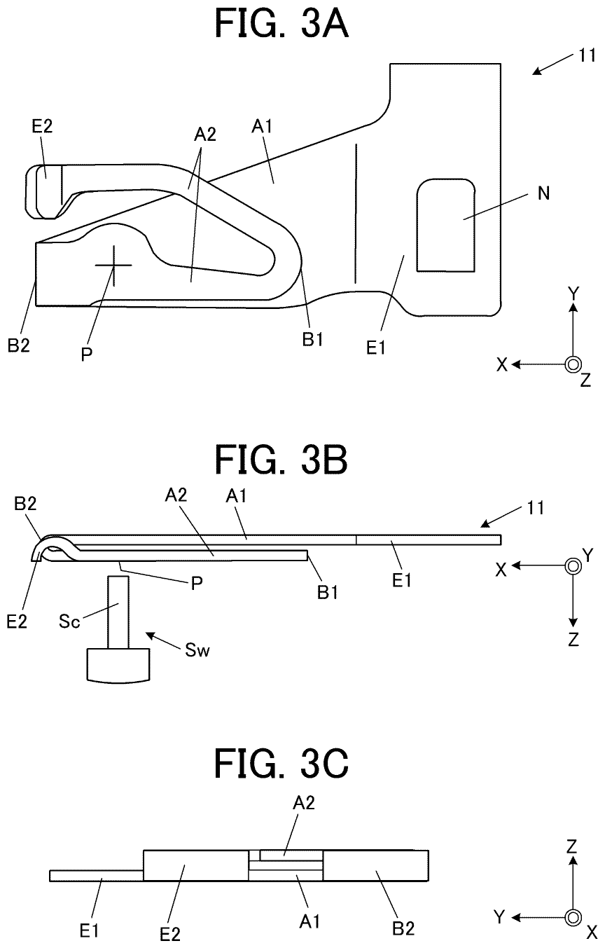

As shown in FIG. 3A, the plate spring 11 extends from the first end E1 in the X direction (first direction) along the lateral surface. In the plate spring 11, the first point P, which is pressed by the shaft Sc of the pushbutton switch Sw, is set. A press direction in which the first point P is pressed by the shaft Sc is the Z direction (second direction). The distance between the first end E1 and the first point P corresponds to the deformability of the plate spring 11 due to the press operation on the pushbutton switch Sw. The shorter this distance, the greater the force required for the press operation to deform the plate spring 11 and is applied on the pushbutton switch Sw. Therefore, as this distance, an appropriate distance is set.

The plate spring 11 may be bent at multiple points. In this embodiment, the plate spring 11 has a first bend B1 and a second bend B2. The first bend B1 is located in a second part A2 between the first point P and the second end E2, provided that this “between” does not include both the ends, i.e., the first bend B1 is not located at the same position as either the first point P or the second end E2. The first bend B1 may be bent in the XY plane along the lateral surface. That is, the second part A2 may be located in a single plane. The second part A2 does not have parts that are on top of one another in plan view, i.e., as viewed in the Z direction. More specifically, parts in front of and behind the first bend B1 of the second part A2 are not on top of one another in plan view. In the second part A2, the direction from the first point P to the first bend B1 and the direction from the first bend B1 to the second end E2 have opposite components at least about the X direction. This makes the length between the first point P and the second end E2 along the second part A2 longer than the distance in a straight line (direct distance) between the first point P and the second end E2.

The second bend B2 may be located in a first part A1 between the first end E1 and the first point P, provided that this “between” does not include both the ends, i.e., the second bend B2 is not located at the same position as either the first end E1 or the first point P. The second bend B2 may be bent in the Z direction. The bending angle of the second bend B2 is approximately 180 degrees, i.e., this bend is a fold of the plate spring 11. The bending part, which includes the second bend B2, may have a curved surface shape with a certain radius of curvature, and accordingly the first part A1 and the second part A2 may be apart from one another in the Z direction by a distance of about twice the radius of curvature. As a result, the first point P is on (also in) the first part A1 in plan view.

When the pushbutton switch Sw is pressed, the plate spring 11 receives force from the shaft Sc of the pushbutton switch Sw at the first point P and moves in the −Z direction. By this movement, the second part A2 contacts the first part A1, and the entire part from the first end E1 exclusive to the tip side of the plate spring 11 moves and deforms in the −Z direction.

As shown by the side view in FIG. 3B, the second end E2 has a curved shape toward the −Z side, which is the side where the substrate 20 of the module 1 is located. Accordingly, as shown in FIG. 3B and FIG. 3C, the bottom part of this curve of the second end E2 is located at the same level as the first part A1 in the Z direction, or at a level further in the −Z direction than the first part A1. Further, the second end E2 is located, of the plate spring 11, at a point farthest from the first end E1 in the X direction. These make the second end E2 the first to deform and move accompanying the deformation of the plate spring 11, and accordingly the second end E2 contacts the electrode 21 of the substrate 20. As a result, the electrode 21 is electrically connected with the case ground plane and an electrical signal is transmitted, so that the press operation on the pushbutton switch Sw is detected in the module 1.

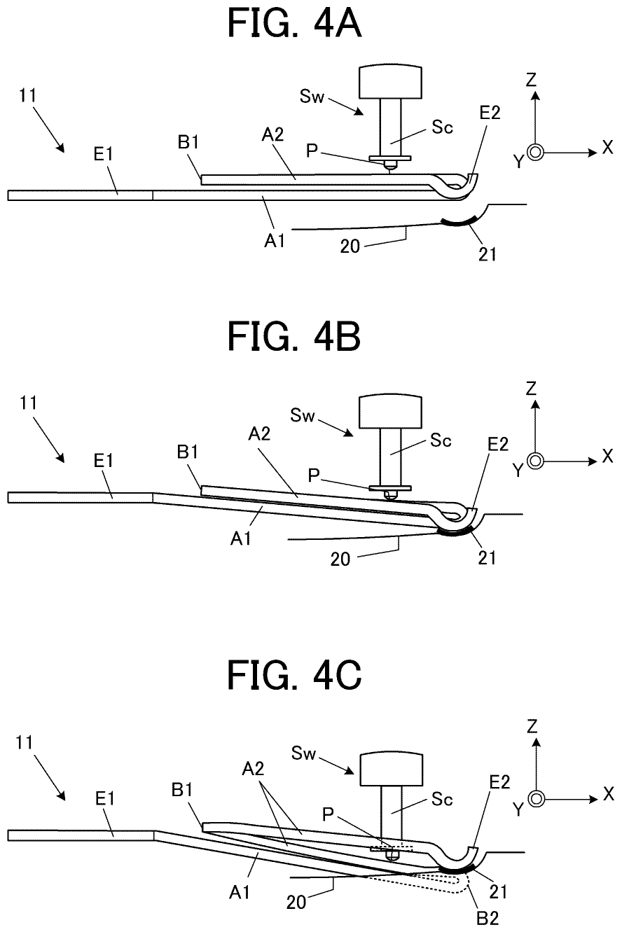

As shown in FIG. 4A, while the pushbutton switch Sw is not pressed and the shaft Sc is not in contact with the plate spring 11, the plate spring 11 does not deform. Accordingly, the second end E2 is not in contact with the electrode 21 of the substrate 20.

As shown in FIG. 4B, when the pushbutton switch Sw is pressed and the shaft Sc contacts the first point P of the plate spring 11, force is applied to the first point P in the −Z direction. This causes the plate spring 11 to bend and deform in the −Z direction with the first end E1 as the fulcrum. When the first point P moves in the −Z direction by a reference amount accompanying the movement of the shaft Sc, the second end E2 contacts the electrode 21.

If, for example, by impact (shock) of dropping the electronic timepiece 100, the pushbutton switch Sw is pressed abruptly and deeper compared to it being pressed by the normal press operation, the plate spring 11 deforms excessively accompanying the movement of the shaft Sc. As shown in FIG. 4C, while keeping the second end E2 in contact with the electrode 21, the plate spring 11 moves, with the first point P as the center, further in the −Z direction with the first end E1 and the second end E2 fixed. If the amount of this movement is too large, the plate spring 11 exceeds the range of elastic deformation and deforms plastically. Thereafter, it is difficult for the plate spring 11 to receive the press operation on the pushbutton switch Sw normally.

The longer the distance between the first point P and the second end E2 and the longer the distance between the first point P and the first end E1, the gentler the deformation angle of the plate spring 11 for the amount of the movement of the first point P and the less likely the occurrence of the plastic deformation. In this embodiment, in particular, the distance from the first point P to the second end E2 via the first bend B1 is sufficiently longer than the direct distance from the first point P to the second end E2. Therefore, the second part A2 is unlikely to deform plastically. In other words, the possibility that the plate spring 11 deforms plastically is low for the length of the plate spring 11 in the X direction.

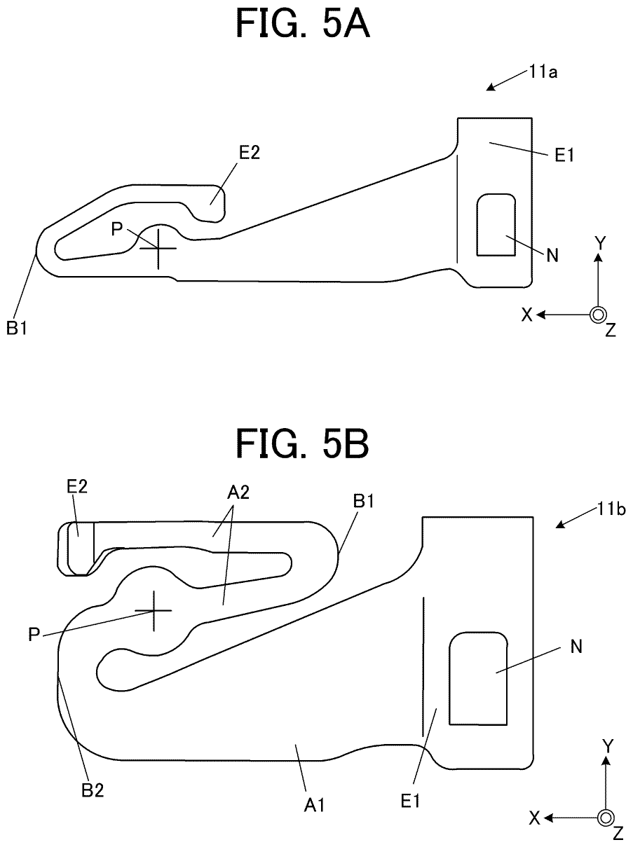

A plate spring 11a of a first modification of the embodiment shown in FIG. 5A has no second bend. The plate spring 11a extends in the +X direction from the first end E1 to the first bend B1 via the first point P. In this plate spring 11a too, the length from the first point P to the second end E2 along the plate spring 11a is longer than the direct distance from the first point P to the second end E2. As a result, even if the first point P is further pressed in the state in which the second end E2 is in contact with the electrode 21, the deformation angles of the plate spring 11a near the second end E2 and at the first point P are gentle for the amount of the movement of the first point P, so that plastic deformation is unlikely to occur.

In a plate spring 11b of a second modification of the embodiment shown in FIG. 5B, the second bend B2 is a planar bend in the XY plane. Accordingly, neither the first point P nor the second part A2 including the first point P has an overlapping part with the first part A1 in plan view. Therefore, when the first point P is pressed, the first part A1 deforms by the deformation of the second part A2 being transmitted thereto via the second bend B2. The plate spring 11b has rigidity for transmitting stress of the deformation throughout itself.

According to this plate spring 11b, the distance (length) from the first point P to the first end E1 and the distance (length) from the first point P to the second end E2 are both longer than the length of the plate spring 11b in the X direction. Therefore, even if excessive force is applied to the first point P, the deformation angles at the fixed first end E1 and the second end E2 in the fixed state for the amount of the movement of the first point P are gentle, so that plastic deformation is unlikely to occur.

As described above, the electronic timepiece 100 (module 1 thereof) of the above embodiment includes the plate springs 11 and the substrate 20. Each plate spring 11 includes the fixed first end E1 and extends from the first end E1 in the X direction. The substrate 20 includes the electrodes 21. Each electrode 21 contacts, of its corresponding plate spring 11, the second end E2 opposite the first end E1 if the first point P of the plate spring 11 is pressed by the pushbutton switch Sw being pressed, for example, by the press operation thereon or the impact of dropping the electronic timepiece 100. On the other hand, the electrode 21 does not contact the second end E2 if the first point P is not pressed. The plate spring 11 further includes the first bend B1 between the first point P and the second end E2. The direction from the first bend B1 to the second end E2 and the direction from the first point P to the first bend B1 are opposite in the component along the X direction. Thus, the first bend B1 makes the length of the plate spring 11 between the first point P, which is pressed by the pushbutton switch Sw, and the second end E2, which comes into contact with the electrode 21, longer than the direct distance therebetween. Therefore, even if the plate spring 11 is pressed excessively by the impact or the like, this does not cause unexpended sharp bending of the second part A2 between the second end E2 supported by the electrode 21 and the first point P. Accordingly, the plate spring 11 is unlikely to deform plastically. Thus, the electronic timepiece 100 having an operation mechanism that is more shock-resistant and space-saving can be obtained. The operation mechanism is composed of, for example, the plate spring(s) 11, the shaft(s) Sc and the electrode(s) 21.

In the switch structure disclosed in JP S56-174430 U, the plate spring does not have a bend between the first point and the second end. Therefore, it has a problem that when excessive impact, which is greater than expected from the press operation on the pushbutton switch, e.g., the impact of dropping an electronic device having the switch structure, is applied to the electronic device, the plate spring may deform irreversibly, and an adverse effect may be exerted on the plate spring in receiving the press operation thereafter. In contrast, the present disclosure can provide the module 1, the electronic device and the electronic timepiece 100 having the operation mechanism that is more shock-resistant and space-saving.

The plate spring 11 may further include the second bend B2 between the first end E1 and the first point P. This makes the length between the first end E1 and the first point P along the plate spring 11 longer than the direct distance therebetween. This can reduce the possibility that due to the first point P being pressed excessively, the plate spring 11 bends at a sharp angle and deforms plastically near the first end E1.

The second bend B2 may be a bend in the second direction (Z direction) that is substantially parallel with the press direction in which the plate spring 11 is pressed, and the first point P may be on the first part A1 of the plate spring 11 between the first end E1 and the second bend B2 as viewed in the Z direction. This can further save space in plan view. Also, since this causes the first part A1 to be pressed at the same time as the first point P is pressed, the first part A1 is hardly distorted even if the first point P is pressed excessively.

The second part A2 of the plate spring 11 between the first point P and the second end E2 may be located in a single plane. This easily deform the second part A2 in conjunction with the first point P being pressed. Even if the first point P is pressed excessively, inclination by excessive deformation is dispersed over the entire second part A2. This reduces the possibility of occurrence of plastic deformation due to large force applied locally. The second bend B2 may have a curved surface shape. The second bend B2 not discontinuously bending makes it unlikely that excessive force is applied locally.

The electronic timepiece 100 includes the pushbutton switches Sw each including the shaft Sc that presses the first point P of its corresponding plate spring 11 in response to the pushbutton switch Sw being pressed. Thus, the electronic timepiece 100 has the operation mechanism that is more robust against the impact of being dropped, and can maintain the stability of the action of the pushbutton switch(es) Sw with more reliability. The electronic device of the present disclosure may be the electronic timepiece 100 described above. The electronic timepiece 100 can maintain the operation mechanism that is more reliable, in particular, when used by the user putting it on and taking it off or moving, such as a wristwatch.

The present disclosure is not limited to the above embodiment but can be changed in a variety of aspects. For example, in the above embodiment, the second end E2 is located next to the first part A1 in the Y direction but not limited thereto. The second end E2 may be located so as to wrap around the tip side of the plate spring 11 in the X direction. Further, the shapes of the first part A1 and the second part A2 are not limited to those described above. Their lengths, their tendencies of change in thickness, presence/absence of curved parts therein and so forth may be changed as appropriate in accordance with, for example, the intensity of the stress of the plate spring 11 and the shape of the movable space of the plate spring 11. Further, the position of the first point P may be changed as appropriate in accordance with the size of the plate spring 11, the magnitude of the stress of the plate spring 11, the positional relationship between the plate spring 11 and the pushbutton switch Sw and/or the like. Further, the shape of the pushbutton switch Sw is not limited to the one described above.

Further, the bending direction of the first bend B1 and the bending direction of the second bend B2 are not limited to the pattern described above. For example, both the first bend B1 and the second bend B2 may be bent in the Z direction. Further, in the case where the second bend B2 is bent in the Z direction, the direction from the second bend B2 to the first point P may be inclined with respect to the X direction.

Further, the number of bends is not limited to one or two. Depending on the internal structure (e.g., size or shape of space inside) of the electronic timepiece 100, the plate spring 11 may have three or more bends. Further, the part where the first part A1 and the second part A2 of the plate spring 11 are on top of one another in plan view is not limited to the one described above. In particular, between the first point P and the second end E2, as long as it does not interfere with the inclination (deformation in the −Z direction) of the part between the first point P and the second end E2 that is in contact with the electrode 21 due to the first point P being pressed excessively, any position can be set as a position where the first part A1 and the second part A2 are on top of one another in plan view.

Further, the operation mechanism configured as described above may be used in an electronic device other than the electronic timepiece 100. In particular, the operation mechanism used in a portable electronic device can reduce failure and malfunction due to the impact of being dropped, which may occur while it is carried around or temporarily placed. The specific configuration, contents and procedures of processes/actions and so forth described in the above embodiment can be changed as appropriate without departing from the scope of the present disclosure. The scope of the present disclosure includes the scope of claims and their equivalents.

1. A module comprising:
a plate spring including a fixed first end and extending from the first end in a first direction; and
a substrate including an electrode that contacts a second end of the plate spring opposite the first end in response to a first point of the plate spring being pressed by a pushbutton switch being pressed and does not contact the second end in response to the first point being not pressed,
wherein the plate spring further includes a first bend between the first point and the second end, and
wherein a direction from the first bend to the second end and a direction from the first point to the first bend are opposite in a component along the first direction.

2. The module according to claim 1, wherein the plate spring further includes a second bend between the first end and the first point.

3. The module according to claim 2,
wherein the second bend is a bend in a second direction that is substantially parallel with a press direction in which the plate spring is pressed, and
wherein the first point is on a first part of the plate spring between the first end and the second bend as viewed in the second direction.

4. The module according to claim 3, wherein the second bend has a curved surface shape.

5. The module according to claim 2, wherein a length of a part from the first bend to the second end in the first direction and a length of a part from the first bend to the second bend in the first direction are substantially equal.

6. The module according to claim 1, wherein a second part of the plate spring between the first point and the second end is located in a single plane.

7. The module according to claim 3, wherein the first bend is on the first part as viewed in the second direction.

8. The module according to claim 3, wherein the first bend is not on the first part as viewed in the second direction.

9. The module according to claim 1, wherein the first bend is a bend in a third direction that is perpendicular to the first direction and a second direction that is substantially parallel with a press direction in which the plate spring is pressed.

10. An electronic device comprising:
the module according to claim 1; and
the pushbutton switch including a shaft that presses the first point of the plate spring in response to the pushbutton switch being pressed.

11. An electronic device comprising:
the module according to claim 2; and
the pushbutton switch including a shaft that presses the first point of the plate spring in response to the pushbutton switch being pressed.

12. An electronic device comprising:
the module according to claim 5; and
the pushbutton switch including a shaft that presses the first point of the plate spring in response to the pushbutton switch being pressed.

13. An electronic device comprising:
the module according to claim 6; and
the pushbutton switch including a shaft that presses the first point of the plate spring in response to the pushbutton switch being pressed.

14. An electronic device comprising:
the module according to claim 9; and
the pushbutton switch including a shaft that presses the first point of the plate spring in response to the pushbutton switch being pressed.

15. An electronic timepiece comprising:
the module according to claim 1; and
the pushbutton switch including a shaft that presses the first point of the plate spring in response to the pushbutton switch being pressed.

16. An electronic timepiece comprising:
the module according to claim 2; and
the pushbutton switch including a shaft that presses the first point of the plate spring in response to the pushbutton switch being pressed.

17. An electronic timepiece comprising:
the module according to claim 5; and
the pushbutton switch including a shaft that presses the first point of the plate spring in response to the pushbutton switch being pressed.

18. An electronic timepiece comprising:
the module according to claim 6; and
the pushbutton switch including a shaft that presses the first point of the plate spring in response to the pushbutton switch being pressed.

19. An electronic timepiece comprising:
the module according to claim 9; and
the pushbutton switch including a shaft that presses the first point of the plate spring in response to the pushbutton switch being pressed.
